(19) United States
(12) Patent Application Publication
(10) Pub. No.: US 2006/0031548 A1
(43) Pub. Date: Feb. 9, 2006

(54) Electronic media distribution system and method

(76) Inventor: Samuel W. Funchess, Greensboro, NC (US)

Correspondence Address: WOMBLE CARLYLE SANDRIDGE & RICE, PLLC, P.O. BOX 7037, ATLANTA, GA, 30357-0037, US

(21) Appl. No.: 11/083,424

(22) Filed: Mar. 18, 2005

Related U.S. Application Data
(60) Provisional application No. 60/554,649, filed on Mar. 19, 2004.

(51) Int. Cl. G06F 15/16

(52) U.S. Cl. 709/231

(57) ABSTRACT

A method of electronically distributing media files to remote users is disclosed. An interactive user interface is provided on at least one remote receiver processor, and a plurality of media files are electronically uploaded from at least one remote media source to a central media storage location upon payment of a source fee. A media stream that includes a series of uploaded media files is broadcast to the remote receiver processor for real-time play of the media stream via the user interface. Remote users are permitted to select one or more media files from either the media stream or the plurality of uploaded media files for play via the user interface, and to select and download one or more media files from the plurality of uploaded media files to a remote storage location upon payment of a user fee. A system for uploading and electronically distributing the media files also is disclosed.

### RELATED APPLICATION

This application claims priority from provisional application Ser. No. 60/554,649, filed Mar. 19, 2004.

### FIELD OF THE INVENTION

The invention relates to systems and methods for electronic distribution of media files, and more particularly relates to a system and method for electronically marketing and distributing digital media files produced by independent artists to remote listeners and purchasers.

### BACKGROUND

Today, independent recording artists can produce “radio ready” digital music tracks easily and inexpensively. Accordingly, traditional label-backed recording studios are no longer essential to the production of high-quality musical recordings. Nevertheless, the major recording companies still control the most popular and profitable distribution channels for recordings on physical media such as compact discs. New methods of electronic distribution and sale of label-backed musical recordings also are available, such as Apple's popular iTunes®.

Known distribution alternatives available to independent recording artists include CDBaby, Amazon.com, and CDStreet.com. Such systems permit artists to submit physical copies of their works for subsequent distribution in a physical format to consumers. Other peer-to-peer file-sharing systems permit individuals to share electronic media files with each other via the Internet. None of these distribution methods, however, includes a radio format option whereby uploaded recordings are randomly broadcast for enjoyment and screening by potential purchasers. Known websites that permit musicians to upload their music require potential purchasers to search for a particular artist by name or genre, or to review a “most downloaded” list for music that matches their specific musical tastes. When a purchaser must use a search feature to find desirable musical content, unknown artists and less well known artists have difficulty getting exposure and encouraging purchased downloads of their music.

Accordingly, there is a need for an electronic media distribution system and method for independent artists that presents electronic audio content to listeners in a convenient broadcast format that increases the exposure of the music to a broad and dispersed audience of listeners, increases listener access to such music, and encourages and enables listeners to purchase copies of such music.

### SUMMARY OF THE INVENTION

One embodiment of the invention includes a system for distributing media files such as digital audio files to remote users. The system includes at least one host server and at least one media server in communication with the host server. The system further includes at least one remote media source processor in communication with the host server and the media server. The media source processor includes a source interface and is configured to upload media files such as digital audio files to the media server. At least one remote media receiver processor also is in communication with the host server and media server. The media receiver processor includes a user interface and is configured to: (1) play media files received in a broadcast media stream from the host server via the user interface, the media stream including a plurality of media files uploaded from the source processor to the media server; (2) permit the remote user to select at least one media file contained in the media stream for further play or for download via the user interface; (3) permit the remote user to select one or more uploaded media files for initial play or for download via the user interface; (4) play at least a portion of a media file selected for initial play or further play by the remote user; and (5) download a media file selected for download by the remote user from the media server to a remote storage location.

The system also may include a source interface that further permits execution of electronic payment transactions between the media source processor and the host server. The user interface also may permit execution of electronic payment transactions between the receiver processor and the host server. Preferably, the media files are digital audio files, though the media files also may be other types of electronic media files such as digital video files.

In another embodiment, the invention includes a method for electronically distributing media files to remote users. The method includes providing an interactive user interface on at least one remote receiver processor. The method further includes uploading a plurality of media files from at least one media source to a central media storage location. The upload of media files from at least one media source to a central media storage location may be conditioned on payment of a source fee such as by an electronic payment method. A media stream is broadcast to the remote receiver processor for real-time play of the media stream via the user interface. The media stream includes a sequence of uploaded media files from the at least one remote media source. Information related to the media stream may be simultaneously displayed to a remote user via the user interface as the media stream is being broadcast. The method further includes permitting the remote user to select one or more media files from either the media stream or the plurality of uploaded media files for further play or initial play via the user interface. The method also includes permitting the remote user to select and download one or more media files from the plurality of uploaded media files to a remote storage location via the user interface. The download of one or more media files from the plurality of uploaded media files to a remote storage location may be conditioned upon payment of a user fee.

The invention provides a niche media distribution system and method for the media industry. The invention is particularly adapted for the marketing and distribution of local and regional musical recordings by independent artists. The invention includes an internet-based radio broadcast system that lowers traditional barriers to entry to mainstream audiences for unsigned artists. The invention permits such artists to publish their music online, and provides artists a greater chance to be heard by a larger audience than the artist's independent marketing efforts and live club network can provide. The invention provides for the distribution of media content from a large pool of independent artists. The invention also provides an inexpensive distribution method for artists' works as opposed to expensive conventional distribution methods and systems that are currently available. The invention includes a streaming broadcast format combined with both upload and download capabilities for digital media files created by independent artists

The invention includes a website that independent artists can access to upload their electronically recorded works for online distribution, and a site for listeners to sample and download media files for future play back. This system and method is different than those currently available. The invention permits independent artists and musicians to upload their musical recordings to be played in an online streaming radio format from which listeners can select and purchase the recordings for future play back. When listeners purchase and download an artist's song, a percentage of the revenue from the sale is paid to the artist who uploaded the song. This motivates artists to contribute to the pool of uploaded music because they directly benefit from the increased exposure of their music. The more listeners, the greater the opportunity that an artist's songs will be purchased. No known Internet music sites provide an artist with the ability to upload electronic music files for distribution, and also permit listeners to listen to the uploaded music in a streaming radio format and to selectively download musical content such as a single selected song.

The radio format of the present invention provides independent artists with an outlet for their music to be heard on a rotational, random-play interval rather than by hit-or-miss search methods used by known online music distributors. The invention provides a method and system for connecting unsigned artists and small labels with music listeners who are looking for new and different music content, especially those listeners who are disenchanted with known radio formats that include repetitive songs, talk radio, and large blocks of advertising.

Contributing artists are enticed to upload their songs for a fee by offering a service that is not currently available to independent artists. This service includes a searchable website with a unique broadcast radio station format that streams a rotation of uploaded songs to listeners. This streaming radio format rotation provides an independent artist a greater chance of being heard by a broader audience versus the industry standard “search” method.

The invention provides an easy to use user interface that allows listeners to select music based on preferences such as style of music or city in which the artist is located. The radio format is designed to keep a listener tuned in for long periods of time by requiring very little interaction by the listener until the listener is ready to make a purchase. Listeners are motivated to access the web-radio format in order to: 1) find new cutting edge music, 2) find a local artist and where the artist is currently playing, or 3) to find a band to play at their business establishment. A website according to the invention also provides a listener with the capability to search for music selections by musician name, song name, city, state, zip code, or musical genre.

A more thorough understanding of the invention may be had from a reading of the following detailed description together with the drawings.

### BRIEF DESCRIPTION OF THE DRAWINGS

FIG. 1 is a schematic diagram of an electronic media distribution system according to the invention;

FIG. 2 is a schematic diagram and flow chart showing a method of distributing media files according to the invention;

FIG. 3 is a screen shot of a first portion of one embodiment of a graphical user interface that may be used in connection with the system and method of FIGS. 1 and 2; and

FIG. 4 is a screen shot of a second portion of one embodiment of a graphical user interface that may be used in connection with the system and method of FIGS. 1 and 2.

### DETAILED DESCRIPTION

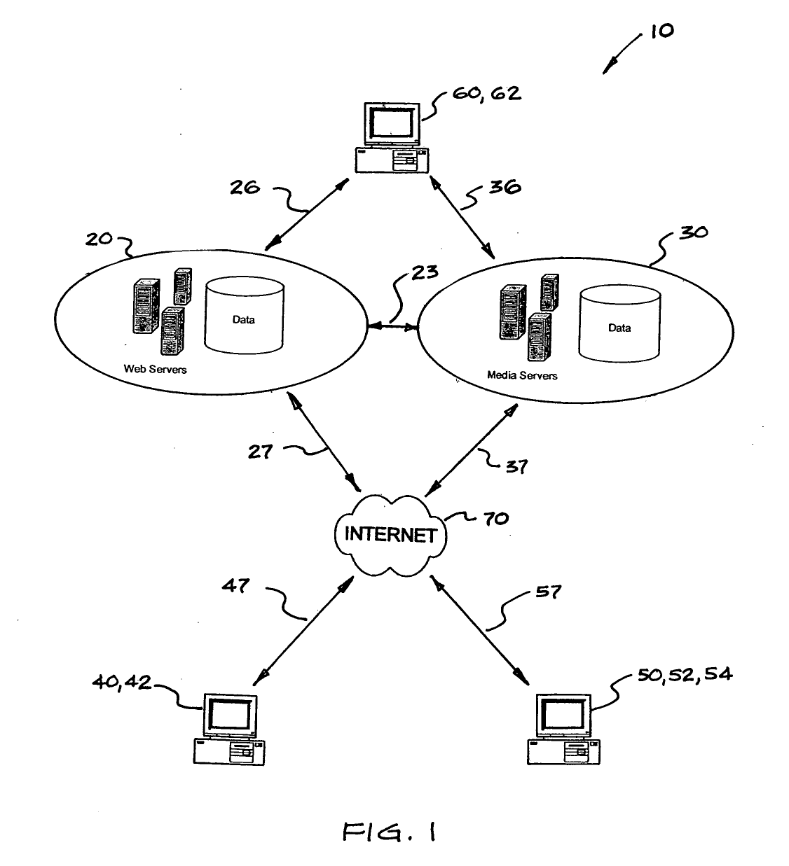

FIG. 1 shows one embodiment of system 10 for distributing electronic media files to a remote user according to the invention. The system 10 includes at least one host server and host database 20 and at least one media server and media database 30. The host server/database 20 and the media server/database 30 are connected by a two-way communication link 23. The system 10 may also include an administrator or control processor 60 for converting/encoding media files and the like. The control processor 60 also includes a live stream broadcast engine 62 capable of sequentially streaming digital audio files via the Internet 70. The control processor 60 is connected to the host media server 30 by a control communication link 36. The control processor 60 may also be connected to the host web server 20 by a direct communication link 26, or by combined communication links 36 and 23. The control processor 60 may be a personal computer or any other suitable CPU.

The system 10 also includes at least one remote media source processor 40 in communication with the host server 20 and the media server 30. As shown in FIG. 1, the remote media source processor 40 preferably is connected to the host server 20 and host media server 30 by either a local area network or wide area network such as the Internet 70. The media source processor includes a source interface 42 and is configured to upload media files such as digital audio files to the media server 30 via communication links 47, 27, and/or 37. The media source processor 40 preferably is a personal computer, but also may be any other CPU with an effective source interface 42. When the media source processor 40 is connected to the host servers 20, 30 via the Internet 70, there may be an unlimited number of source processors 40.

The system 10 also includes at least one remote media receiver processor 50 in communication with the host server 20 and media server 30. The media receiver processor 50 includes a user interface 52, and is configured to: (i) play media files received in a broadcast media stream from the host servers 20, 30 via the user interface 52, the media stream including a plurality of media files uploaded from the source processor 40 to the media server 30; (ii) permit a remote user of the media receiver processor 50 to select at least one media file contained in the media stream for further play or for download via the user interface 52; (ii) permit a remote user of the receiver processor 50 to select one or more uploaded media files for initial play or for download via the user interface 52; (iii) play at least a portion of a media file selected for initial play or further play by the remote user using the user interface 52; and (iv) download a media file selected for download by the remote user from the media server 30 to a remote storage location 54. Preferably, the receiver processor 50 is a personal computer and the user interface 52 is an interactive graphical interface. Preferably, the Internet connection 57 is a high-speed connection.

Preferably the system 10 includes a source interface 42 that facilitates execution of electronic payment transactions between the media source processor 40 and the host server 20. The user interface 52 also preferably permits execution of electronic payment transactions between the receiver processor 50 and the host server 20. The user interface 50 also preferably includes a virtual shopping cart that permits a user to create a list or “cart” of media files for download prior to purchase.

Though the system 10 primarily is described above as a system for the upload, broadcast, and selective download of digital audio files, the system 10 can also be used to distribute other types of electronic media files such as digital video files.

The user interface 52 and source interface 42 may be part of a single processor interface. For example, the user interface 52 and source interface 42 may be provided on a common website, or may be parts of a single application program.

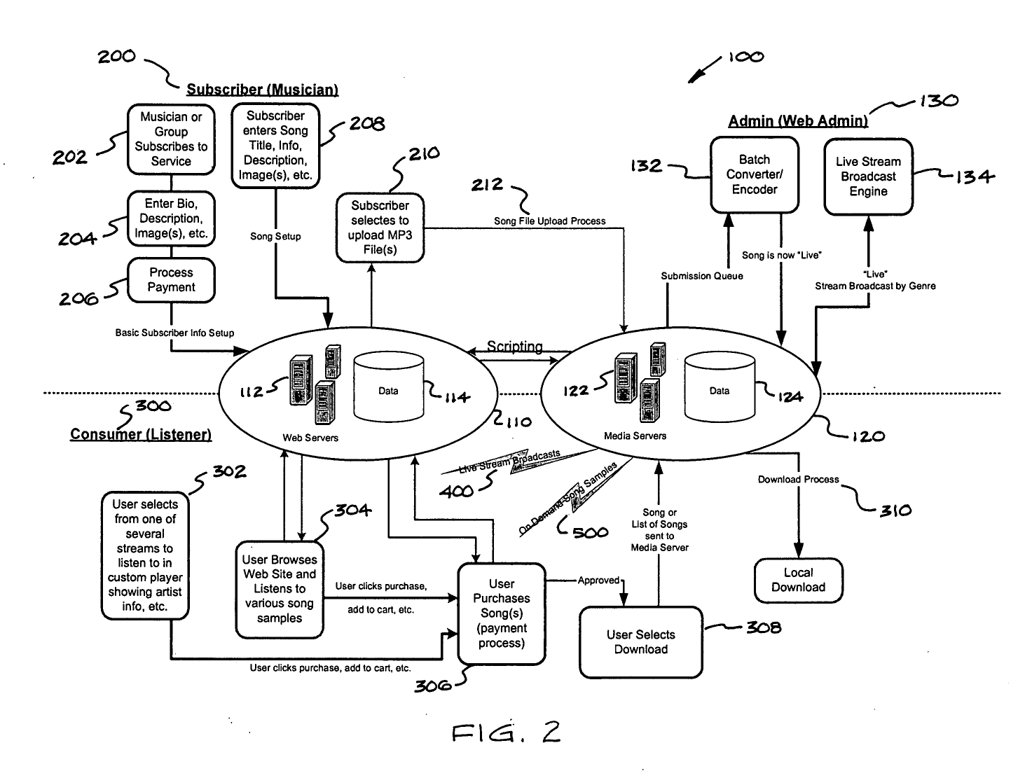

The invention also includes a method for electronically distributing media files to remote users. One embodiment 100 of the method according to the invention is shown in FIG. 2. The method 100 includes uploading 212 a plurality of media files from at least one remote media source (hereinafter referred to as the “subscriber” or “musician” 200) to a central media storage location 120. The subscriber's 200 ability to upload files preferably is conditioned upon pre-payment of a subscription fee 202-206. Prior to uploading a file 212, a subscriber supplies song setup information 208 and selects the setup song for upload 210.

The method 100 further includes providing an interactive user interface on at least one remote receiver processor (hereinafter referred to as the “consumer” or “listener” 300). At least one media stream is broadcast 400 to the consumer 300 for real-time play 302 of the media stream via the user interface. The broadcast media stream includes a sequence of uploaded media files from the at least one subscriber 200. The uploaded media files include audio content, and also may include video content. The method 100 may also include displaying information 302 related to the broadcast media stream to the listener 300 via the user interface as the media stream is being broadcast 400. Optionally, the listener may be required to pay a subscription fee to enable the listener to receive of the broadcast media stream. Preferably, the listener 300 can use the user interface to select 302 a particular media stream or channel from one of several broadcast media streams or channels. The listener 300 optionally selects 304 one or more uploaded media files from either the live media stream as it is broadcast 400 or from the plurality of uploaded 212 media files for further play or initial play 500 via the user interface. The listener 300 selects 308 and downloads 310 one or more media files from the plurality of uploaded media files to a remote storage location via the user interface. The listener's 300 ability to download files 310 preferably is conditioned upon pre-payment 306 of a purchase fee. For example, where the media files are audio files containing a single song, electronic pre-payment of 99-cents per song title may be required before each media file can be downloaded.

Payments for uploading 212 or downloading 310 media files may be transacted 206, 306 via known electronic financial transaction methods such as by credit card, debit card, or PayPal®. These payments may be received from a musician 200 when the artist 200 uploads 212 a digital music file to the system, and from a listener 300 when the listener 300 purchases a music file for download 310 from the system. Other fees may be electronically collected from musicians 200 and listeners 300 for other services provided by the system or as part of the process 100. For example, contributing musicians 200 may be charged a special subscription fee 206 for having their songs randomly broadcast 400 in a web-radio format for a finite period of playtime.

Preferably, listeners are charged a fee 306 for each download 310 of a media file for the customers' personal use. For example, listeners may be charged 99 cents to download 310 a digital audio media file containing a single song title. Preferably, artists are charged a fee 206 to upload music files 210, 212 to make the music available for play 400 and downloading 310. Artists who upload music 210, 212 preferably receive commissions for each song that is actually purchased (not shown in FIG. 2). Commissions may be paid on a sliding scale. For example, for the first 100 songs purchased and downloaded, the musician might receive 15 cents from each purchase; for the next 101-1000 purchases, the artist might receive 25 cents from each purchase; and for each downloaded song over 10000 songs, the artist might receive 35 cents from each purchase.

Preferably, the artist is charged a monthly fee 206 to randomly stream 400 an uploaded song in the web-radio format. This fee may based on what features an artist or source 200 selects, as well as the number of musical genres the selects for placement of each song in rotation for broadcast 400, for example. In addition to uploads 200, 212 of digital audio files, artists also may upload 204 photographs or other information such as text or video clips or digital music video files or clips. The user interface may permit the pictures or other information to be graphically displayed in the media player while the artist's song is played 302, 304.

Preferably, upload pricing is structured to entice contributing artists 200 to only place their best songs in rotation for streaming online broadcast 400, thereby improving the quality of music being played in rotation. Artists may be allowed to upload music 210, 212 that may be purchased but not played 400 at no cost. In this way, if a listener 300 likes a particular artist 200, they can purchase 304, 306 additional music by that artist. The invention provides a distribution channel that principally is electronic. This allows the user immediate satisfaction from their purchase to make their own CD. The invention may also include means for a customer to have a selected list of songs burned to a CD and mailed to the customer for an additional fee (not shown in FIG. 2).

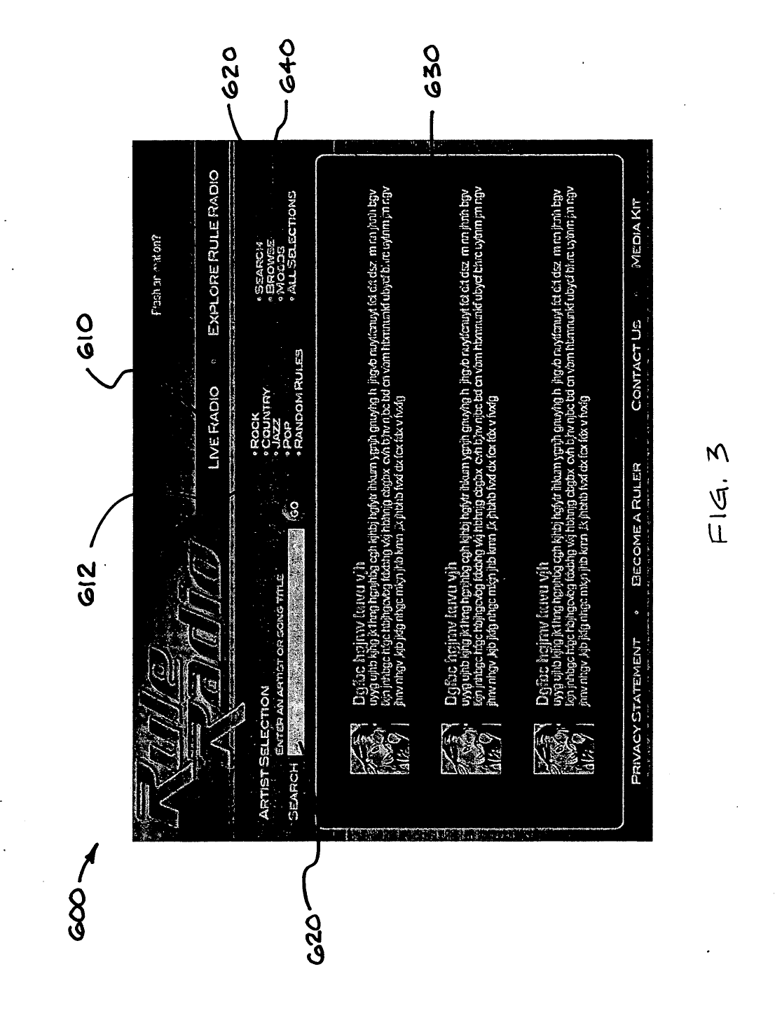

FIG. 3 shows a screen shot of an interactive graphical user interface that may be used in the system 10 and process 100 described above. The page 600 presents a listener 300 with various options for selection. For example, hot button 610 permits a listener 300 to click on the button 610 to listen to a live streaming broadcast 400 of uploaded songs. The listener 300 also has the option of selecting a specific genre of music 612 for listening to specific type of music, such as rock, country, jazz, pop, etc. A listener also has the option to search 620 or browse 640 for music by a particular artist, having a particular title, or by another selection criteria. Other information that may be of interest to a listener may be graphically displayed in a window 630 in the page 600.

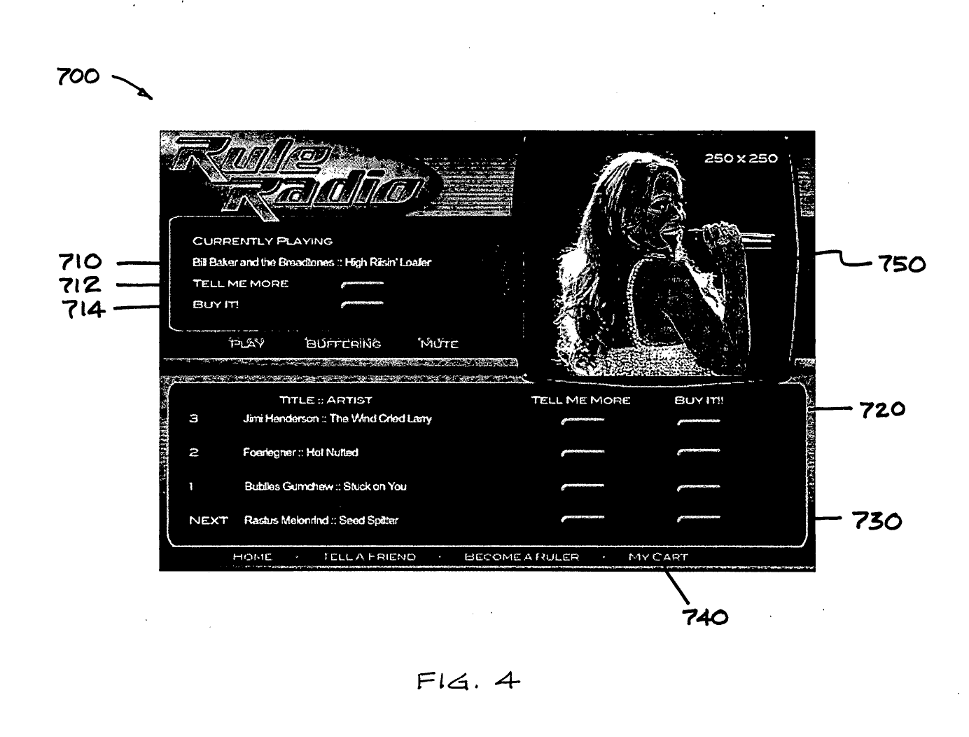

FIG. 4 is a screen shot of another page 700 that may part of an interactive user interface for a listener 300. For example, page 700 may be presented to listener 300 after the listener has selected “live radio” from the selection screen 600 of FIG. 3. As a listener listens to a broadcast stream, page 700 displays information 710 pertaining to a currently broadcast song, such as song artist and title. A listener 300 also has the option of learning more about the song or artist by clicking on the “tell me more” button 712. The listener also can select the song for purchase and download by clicking the “buy it!” button 714. The purchase button 714 may cause a selected song to be placed in a shopping cart 740 so that multiple purchasing transactions can be transacted at one time. Photos, video images, or other graphics pertaining to a particular song may be displayed in a frame 750 as the song is played. Songs that are pending streaming broadcast or have been placed in a play list by a listener 300 also may be displayed 730.

The above detailed description is intended to describe specific embodiments of the invention. The description is intended to illustrate various aspects of the invention rather than define or limit the metes and bounds of the invention. Persons of ordinary skill in the art will appreciate that modifications may be made to the described embodiment(s) without departing from the scope of the invention. For example, though the system 10 and method 100 described above are particularly suited for the distribution of audio media files, other types of media and multi-media files can also be distributed with the described system 10 and method 100. All such modifications are intended to be within the scope of the appended claims.

I claim:

1. A system for distributing media files to a remote user, the system comprising:
(a) at least one host server;
(b) at least one media server in communication with the host server;
(c) at least one remote media source processor in communication with the host server and the media server, the media source processor including a source interface and being configured to upload media files to the media server;
(c) at least one remote media receiver processor in communication with the host server and media server, the media receiver processor including a user interface and being configured to:
(i) play media files received in a broadcast media stream from the host server via the user interface, the media stream comprising a plurality of media files uploaded from the source processor to the media server;
(ii) permit the remote user to select at least one media file contained in the media stream for further play or for download via the user interface;
(ii) permit the remote user to select one or more uploaded media files for initial play or for download via the user interface;
(iii) play at least a portion of a media file selected for initial play or further play by the remote user; and
(iii) download a media file selected for download by the remote user from the media server to a remote storage location.

2. A system according to claim 1 wherein the remote media source processor communicates with the host server and the media server via the Internet.

3. A system according to claim 1 wherein the remote media receiver processor communicates with the host server and the media server via the Internet.

4. A system according to claim 1 wherein the remote media receiver processor comprises a personal computer workstation.

5. A system according to claim 1 wherein at least a portion of the media files uploaded from the remote media source processor to the media server comprise audio content produced by an independent artist.

6. A system according to claim 1 wherein the remote media receiver processor and user interface are configured to permit submission of an electronic payment that is commensurate with a quantity of media files downloaded from the media server to the remote storage location.

7. A system according to claim 1 wherein the remote media source processor and source interface are configured to permit submission of an electronic payment that is commensurate with a quantity of media files uploaded from the remote media source processor to the media server.

8. A method of electronically distributing media files to remote users, the method comprising:
(a) providing an interactive user interface on at least one remote receiver processor;
(b) electronically uploading a plurality of media files from at least one remote media source to a central media storage location upon payment of a source fee;
(c) broadcasting a media stream to the remote receiver processor for real-time play of the media stream via the user interface, the media stream comprising a series of uploaded media files from the at least one remote media source;
(d) permitting the remote users to select one or more media files from either the media stream or the plurality of uploaded media files for play via the user interface; and
(e) permitting the remote users to select and download one or more media files from the plurality of uploaded media files to a remote storage location via the user interface upon payment of a user fee.

9. A method according to claim 8 wherein at least a portion of the media files comprises audio content produced by an independent artist.

10. A method according to claim 8 wherein broadcasting a media stream to the remote receiver processor is via the Internet.

11. A method according to claim 8 wherein the user fee is commensurate with a quantity of media files downloaded to the remote storage location.

12. A method according to claim 8 wherein the source fee is commensurate with a quantity of media files uploaded from the remote media source to the central media storage location.

13. A method according to claim 8 wherein the broadcast media stream further comprises advertising information.

14. A method according to claim 8 wherein the broadcast media stream further comprises commentary regarding the media stream.

15. A method of distributing audio content created by an artist, the method comprising:
(a) providing an Internet-based media distribution platform comprising a host computer;
(b) permitting the artist to directly upload a media file containing the audio content from a remote location to the host computer system upon payment of a source fee;
(c) broadcasting the audio content in a media stream to a plurality of remote listeners; and
(d) permitting at least one of the remote listeners to selectively replay the audio content.

16. A method according to claim 15 further comprising permitting at least one of the remote listeners to selectively download the media file to a remote storage location upon payment of a user fee.

17. A method according to claim 15 wherein broadcasting the audio content in a media stream to a plurality of remote listeners comprises collecting a subscription fee from a remote listener before permitting the listener to receive the broadcasted audio content.

18. A method according to claim 16 further comprising paying a commission to the artist that is related to the number of downloads of the media file by remote listeners.

19. A method according to claim 15 further comprising communicating information related to the audio content as the audio content is broadcast in the media stream.

20. A method according to claim 15 further comprising broadcasting video content as the audio content is broadcast in the media stream.
